(19) United States
(12) Patent Application Publication
(10) Pub. No.: US 2019/0303034 A1
(43) Pub. Date: Oct. 3, 2019

(54) WEAR MITIGATION THROUGH DATA PROMOTION IN A HIERARCHICAL MEMORY

(71) Applicant: Seagate Technology LLC, Cupertino, CA (US)

(72) Inventor: Mark A. Gaertner, Vadnais Heights, MN (US)

(73) Assignee: Seagate Technology LLC

(21) Appl. No.: 15/944,046

(22) Filed: Apr. 3, 2018

(51) Int. Cl. G06F 3/06; G06F 12/0868; G06F 12/02

(52) U.S. Cl. CPC G06F 3/0649; G06F 3/0617; G06F 2212/7211; G06F 12/0238; G06F 12/0868

(57) ABSTRACT

Method and apparatus for distributing wear in a data storage system. In some embodiments, a first data transducer is used to record data to a first data recording surface. Performance statistics are accumulated including a dwell metric value indicative of relative dwell time of the first transducer adjacent a selected radial location on the first data recording surface and an operational life metric value indicative of accumulated elapsed operation of the first transducer. A data migration mode is enacted to migrate data from the selected radial location to a local memory in a hierarchical memory structure responsive to at least a selected one of the dwell metric value or the operational life metric value. Host access commands are temporarily serviced from the local memory, after which the data are returned to the selected radial location or a new location in a disc stack main memory store.

### SUMMARY

Various embodiments of the present disclosure are generally directed to a method and apparatus for managing a data storage system that utilizes uses moveable data transducers adjacent rotatable data recording media.

In some embodiments, a method includes steps of recording data to a first rotatable data recording surface using a first data transducer, and accumulating a dwell metric value indicative of at least a selected one of dwell time of the first transducer adjacent a selected radial location on the first rotatable data recording surface and an operational life metric value indicative of accumulated elapsed operation of the first transducer. Data are migrated from the selected radial location to a local memory responsive to at least a selected one of the dwell metric value or the operational life metric value exceeding a selected predetermined threshold. At least one subsequently received access command for the data is serviced to transfer a portion of the data between the local memory and a host device without accessing the selected radial location on the first rotatable data recording surface and without using the first data transducer. The data are subsequently transferred from the local memory to the first rotatable data recording surface using the first data transducer or to a different, second rotatable data recording surface using a different, second data transducer.

### BRIEF DESCRIPTION OF DRAWINGS

FIG. 1 is a functional block diagram of a data storage device constructed and operated in accordance with various embodiments of the present disclosure.

FIG. 2 is a schematic representation of aspects of the data storage device of FIG. 1. In some embodiments.

FIG. 3 shows a heat assisted magnetic recording (HAMR) transducer and associated rotatable data recording medium from FIG. 2 in some embodiments.

FIG. 4 is a side elevational cross-sectional representation of a disc stack of the data storage device in accordance with some embodiments.

FIG. 5 shows an arrangement of a data recording surface of the data storage media arranged into a plurality of data zones and a disc media cache.

FIG. 6 illustrates various intermediate memory locations in a hierarchical memory structure of the data storage device in some embodiments.

FIG. 7 is a functional block representation of a wear mitigation circuit in accordance with some embodiments.

FIG. 8 is a flow chart for an excessive wear mitigation routine illustrative of steps carried out by the circuit of FIG. 6 in accordance with some embodiments.

FIG. 9 illustrates a bloom filter from FIG. 6 in accordance with some embodiments.

FIG. 10 shows a narrow band dwell monitor circuit from FIG. 6 in accordance with some embodiments.

FIG. 11 is a flow chart for a background migration routine of FIG. 6 in some embodiments.

FIG. 12 shows a data migration operation to migrate existing stored data in the system to a new memory location during the routine of FIG. 11.

FIG. 13 is a flow chart for a forward migration routine of FIG. 6 in some embodiments.

FIG. 14 illustrates concurrent operation of the respective background and foreground operations.

FIG. 15 shows an expansion of the existing disc media cache of FIG. 5 as required to accommodate the temporarily cached data from FIG. 6.

### DETAILED DESCRIPTION

The present disclosure is generally directed to data storage systems, and more particularly to mitigating wear disturbance in a data storage system that employs multiple data recording media and data transducers, including but not limited to heat assisted magnetic recording (HAMR) systems.

Data storage devices store and retrieve data in a fast and efficient manner. Some data storage devices employ rotatable magnetic recording media (discs) which are rotated at a high rotational velocity. An array of data transducers (heads) are movably positioned adjacent tracks defined on the disc surfaces to write and read data. The heads may be aerodynamically flown in close proximity to the disc surfaces using circulating atmospheric currents (e.g., air, helium, etc.) established by high speed rotation of the discs. Generally, flying the discs at a low head-media spacing (HMS) fly heights can enhance data densities and transfer rates, so successive generations of drives have endeavored to achieve ever decreasing HMS values.

Heat assisted magnetic recording (HAMR) is another technique that has been employed in some devices to enhance data densities and transfer rates. HAMR generally refers to the use of electromagnetic energy to assist in the magnetic recording of data. A HAMR system generally includes a source of electromagnetic radiation (EMR), such as but not limited to a laser diode. The source locally heats the magnetic recording medium to a temperature near or above the Curie temperature of the magnetic material. In this way, the magnetic coercivity of the material will be significantly lowered during a write operation, allowing a magnetic field from a magnetic write element to write a desired magnetization pattern to the media. HAMR systems can take any number of forms including microwave assisted magnetic recording (MAMR) systems, etc.

Some HAMR systems utilize a near field transducer (NFT) to assist in the focusing of the electromagnetic energy onto the magnetic recording media. Generally, NFTs tend to wear out faster than other elements in the system. Empirical evidence suggests that NFTs follow the well known reliability bath-tub curve; many initial failures (largely screened during manufacturing), a relatively long stable period of random failures, followed by a sharp increase in end of life failures.

NFT failures are often a function of total operational hours and laser power used by the HAMR system. Operational hours may be expressed using a metric sometimes referred to as WPOH (write power on hours), or some other suitable metric. The WPOH value may be an accumulated total on-time, or may be an adjusted value to account for differences in laser power settings, recording locations, etc.

With the advent of HAMR and reduced HMS, data storage devices can be susceptible to reliability issues relating to excessive access by a head to a particular area of the disc media. For HAMR, one issue is that the heads have limited WPOH capability, so excessive write accesses using a subset of the total number of available heads can cause those heads to fail more quickly as compared to if a uniform distribution of write accesses were used. Non-uniform distributions of WPOH can arise in other ways as well. It will be noted that WPOH can be assessed either as consumed life or remaining life.

For HMS, concentrated read/write accesses or passive dwell times to a small region of the disc media can disrupt the thin lubrication (lube) layer that protects the heads and the media from inadvertent contact events. If sufficiently pronounced, lube degradation and displacement issues can result in read/write errors and, ultimately, total device failures. Even for non-HAMR based heads, excessive utilization of one or more of the heads can lead to premature failure of those heads, leading to a benefit of extended life and improved operation through media-based wear leveling.

Accordingly, various embodiments of the present disclosure are generally directed to an apparatus and method for mitigating these and other wear and dwell time related effects. As explained below, some embodiments are directed to a data storage device that employs a heat assisted magnetic recording (HAMR) system with a transducer having a source of electromagnetic radiation (EMR) configured to assist in the magnetic writing of data to an associated data recording surface. This is illustrative but not necessarily limiting.

A mitigation circuit monitors operation of the data storage device including by monitoring and evaluating WPOH distributions across the various heads and dwell time performance of the individual heads. WPOH can be measured in terms of consumed operational time or estimated remaining operational life. Other quality metrics can be used indicative of head life as WPOH values. The mitigation circuit periodically transitions from a normal mode to a data migration mode based on either or both of these factors reaching a predetermined threshold.

During the migration mode, data are temporarily migrated and diverted away from the main storage area of the discs associated with the wear condition. A background operation and/or a foreground operation are initiated during the migration mode. The background operation generally evaluates an amount of data that should be migrated from the head/disc location experiencing the wear condition and proceeds to migrate that data to a local memory of the data storage device. The local memory can take a variety of forms, including a disc media cache, a flash memory, a write buffer, a read buffer, etc. The memory represents a temporary location for the data away from the main store (referred to as the discs or the disc stack).

The foreground operation continues during the pendency of the migration mode to evaluate new access operations from an external host to determine whether the access operations are associated with the migrated data. If so, the access operations are serviced using the local memory location; read commands involve reading the requested data (e.g., LBAs) from the local memory, and write commands involve writing the input write data to the local memory. In some cases, read data may be cached in volatile memory (VM) such as DRAM or SRAM, while write data may be cached in non-volatile memory (NVM) such as the disc media cache, flash, write cache, etc.

It is contemplated that a wear condition associated with lube disturb (lubricant disturbance) will self-heal over time based on the fluidic flow capabilities of the lubricant, provided no or few accesses continue to be made to the disturbed area by the associated head. In some embodiments, the data are serviced in the local memory location during a high access period of time, so that once host activity has dropped to a reasonable level, the migrated data are moved back from the local memory to the main disc store. A new location (head/zone) may be selected for the data based on the then-existing monitored parameters; for example, if the migrated data came from a head having a relatively high WPOH value, the data may be moved back to a different head having a relatively low WPOH value. In other cases, the data may be returned to the original location in the disc stack. It is noted that if the data are migrated back to the original location, only those data blocks that were updated may need be written, reducing the time required to complete the return of the data to the disc stack.

In some cases, multiple wear locations may be concurrently monitored and migrated so that multiple data sets are temporarily cached in the local memory location(s). In still other cases, data from zones having highest relative wear activity may be migrated to enable localized servicing from faster memory, after which the data may be returned.

The data may be arranged in fixed size host addressable blocks (sectors), such as 512 bytes, 1024 bytes, etc. These addressable sectors may in turn be grouped into larger multi-sector blocks or sets of data, such as 256 MB blocks in accordance with an existing data block storage standard (e.g., T10/T13 ISO standard, etc.). A virtualized mapping approach is used to maintain one or more map structure that identifies the locations of the various sets of data. Each map structure is updated as required to accommodate the data migration operations. Separate mapping structures may be utilized for the respective main store and local memory, with the local mapping potentially having the ability to track variable length LBA ranges.

Various methodologies can be used to detect both WPOH distributions and dwell time disturbances. For dwell times, one method can utilize a narrow band dwell monitor circuit that estimates or computes a free lube distribution based on a number of input parameters. For WPOH distributions, various techniques can be used including monitoring and calculating individual WPOH values, using a bloom filter, etc. In some embodiments, a WPOH issue may be detected, and the bloom filter or other mechanism can be used to identify LBA ranges to migrate; for example, if head 0 is being worn excessively, the bloom filter can be used to identify the data range that is most frequently written using head 0.

Different combinations of these and other techniques can be used to signal the transitioning to the data migration mode. While various embodiments are particularly directed to HAMR-based heads, the techniques disclosed herein can also be utilized to obtain improved wear leveling among a population of non-HAMR based heads.

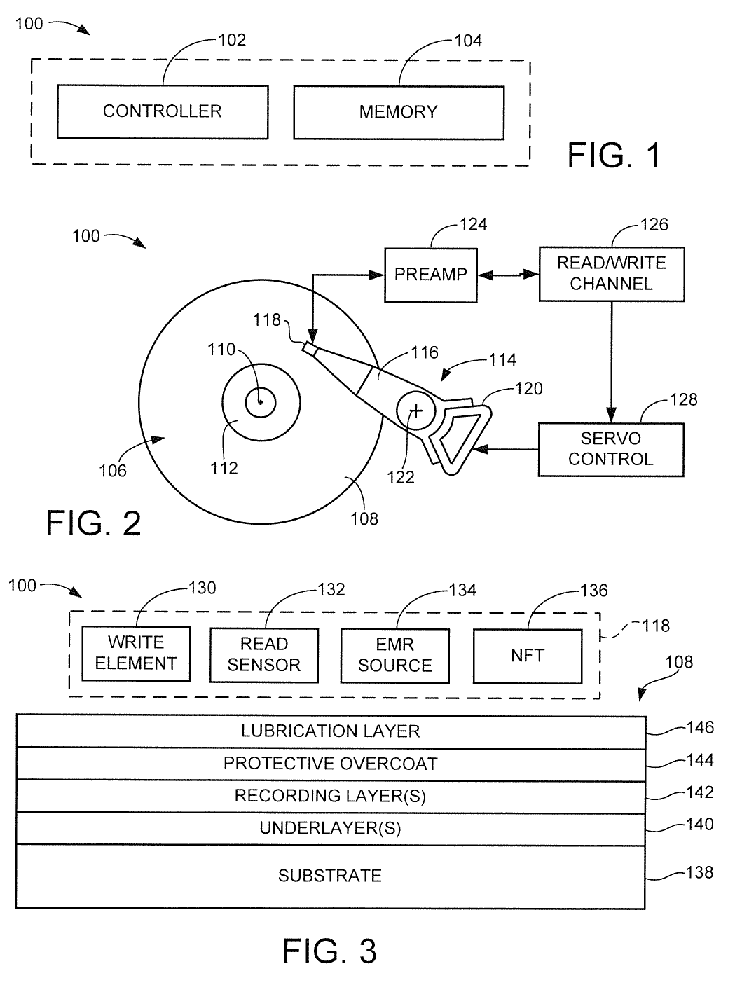

These and other features and advantages of various embodiments can be understood beginning with a review of FIG. 1 which shows a data storage device 100. The data storage device 100 includes a top level controller 102 and a memory 104. The controller can be a hardware and/or software/firmware based processor circuit that provides top level control for the device. The memory 104 can take any variety of forms. For purposes of the present disclosure, it is contemplated that the memory 104 includes one or more rotatable data recording media (discs) to which data are written using a heat assisted magnetic recording (HAMR) system.

FIG. 2 is a schematic representation of aspects of the storage device 100 of FIG. 1. The device 100 is characterized as a hard disc drive (HDD), although other configurations can be used. The device 100 includes a media stack 106 made up of one or more rotatable magnetic recording media (discs) 108 that are axially aligned for rotation about a central rotational axis 110 by a spindle motor hub assembly 112.

A rotary actuator 114 is mounted adjacent the media stack 106 and includes one or more actuator arms 116 that extend to support a corresponding array of data transducers (heads) 118 adjacent the surfaces of the discs 108. A coil 120 of a voice coil motor, VCM (not separately shown) facilitates rotary movement of the actuator 114 about a pivot point 122 to controllably advance the heads 118 across the media surfaces.

A preamplifier/driver circuit (preamp) 124 provides control signals utilized by the heads 118. The preamp 136 may further include multiplexor (mux) selection logic to enable the individual selection of the various heads as required.

A read/write (R/W) channel 126 provides signal conditioning of input write data during a write operation and readback signal processing of readback signals during a read operation. A servo control circuit 128 receives demodulated servo information written to various tracks on the media surfaces to enable closed loop positional control of the respective heads.

FIG. 3 is a schematic representation of a selected head-media combination from FIG. 2 in accordance with some embodiments. The head 118 is characterized as a HAMR-based head, although other configurations can be used. The selected head 118 includes a number of operational elements including a write element 130, a read sensor 132, an electromagnetic radiation (EMR) source 134 and a near field transducer (NFT) 136. Other elements may be included as well such as a fly height adjustment (FHA) mechanism, a proximity sensor, a microactuator, a laser power detector, etc., but such have been omitted for simplicity of illustration. These elements may be incorporated in or on a slider (not separately designated) having an air bearing surface (ABS) configured to maintain the transducer at a stable fly height above (clearance distance from) a recording surface of the adjacent magnetic recording medium 108.

The medium 108 has a number of layers including a base substrate 138, one or more underlayers 140, one or more magnetic data recording layers 142 and a protective overcoat layer 144, such as a carbon overcoat (COC) layer. Disposed on top of the COC layer 144 is a thin layer of lubricant (lube) 146. The lube layer may be a hydrocarbon based or similar fluid that provides a lubricating layer to reduce the propensity of damage to the head 118 and/or the disc 108 based on inadvertent head-disc contact.

The write element 130 may be a perpendicular magnetic recording element with a coil and pole configuration to direct concentrated magnetic flux into the recording layer 142. The read sensor 130 may take a magnetoresistive (MR) construction and operates to provide a variable electrical resistance in the presence or absence of a magnetic field to sense the previously written magnetic pattern from the recording layer 142.

The EMR source 134 may take the form of a laser diode that applies collated light energy at a selected wavelength to provide localized heating of the recording layer 142 to lower the magnetic coercivity of the layer during a write operation. The light may be transferred by a waveguide or other light conducting channel. The NFT 136 may take the form of a semiconductor based element that can be used to focus the light from the EMR source (e.g., laser diode) onto the medium 108.

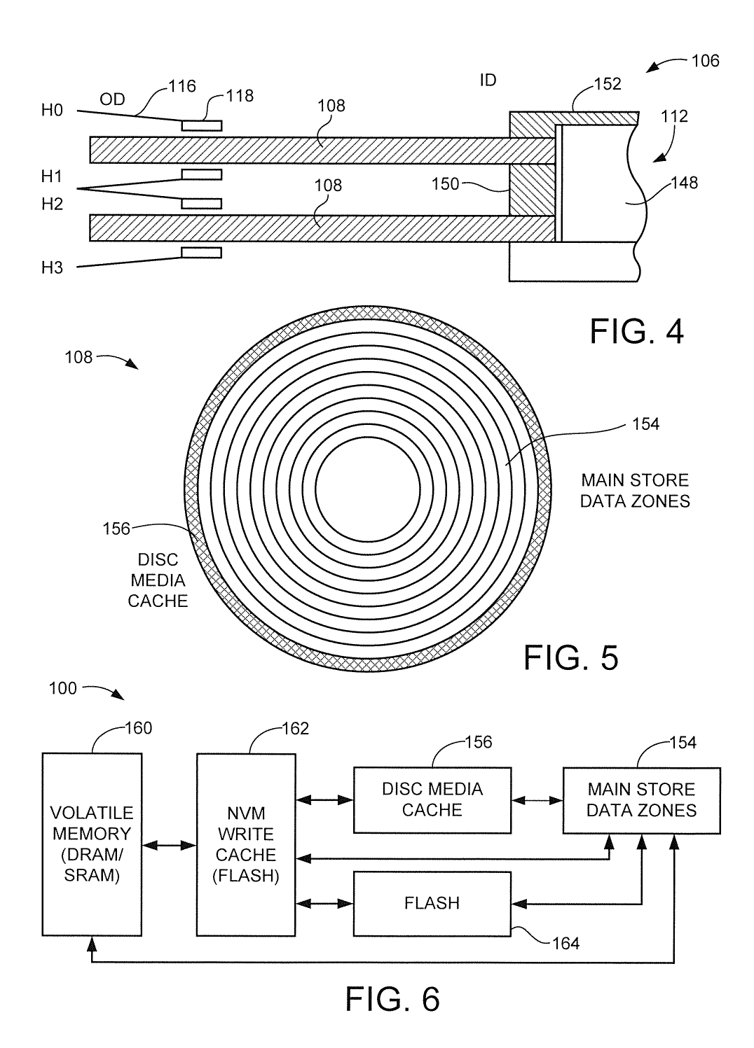

The disc stack 106 from FIG. 2 may employ multiple discs 108. FIG. 4 shows an example configuration of the disc stack with two (2) discs 108 and four (4) heads 118. The discs 108 are axially aligned and mounted to a rotatable spindle motor hub 148 of the hub assembly 112. The discs are spaced using an intervening disc spacer 150 and clamped to the spindle motor hub 148 using a clamp member 152. Each of the four heads 118 accesses a different recording surface of the discs 108 and uses a HAMR system to record data thereto as shown in FIG. 3. For reference, the heads are respectively identified as HO-H3.

It is common in a HAMR system to change the laser power across the stroke of the actuator 114 (FIG. 2) so that different power values are used from the outermost diameter (OD) to the innermost diameter (ID) of the discs. Generally, some HAMR systems operate such that the laser power is higher at the OD as compared to the ID. This change in laser power arises based on a number of factors, including the fact that in constant linear velocity (CLV) recording systems where the discs are rotated at a constant velocity, generally higher data recording frequencies will be used at the OD as compared to the ID. Similarly, different laser power levels may be used for different locations within the disc stack 106. For example, interior heads H1 and H2 may operate at higher temperatures than the outer heads HO and H3, so lower power levels may be applied to the interior heads.

Both HAMR based heads and non-HAMR based heads can also be subjected to different parametric and power level inputs based on head location. For example, higher write current levels (and read bias current levels) can be supplied to data written near the OD to compensate for higher data transfer rates. Similarly, different fly height adjustment values may be supplied to interior heads (e.g., H1 and H2) to compensate for different ambient operational temperature profiles, and so on. These and other factors can also contribute to different amounts of relative wear of the heads.

FIG. 5 shows an example arrangement of a selected recording surface of a disc 108 into a plurality of concentric data regions 154. This is optional as other arrangements can be used. Each data region 154 is also referred to as a main store data zone and comprises a plurality of immediately adjacent data tracks configured to store a selected amount of user data. The data tracks store the data in fixed-sized data sectors, or data blocks. Each zone 154 may correspond to a total common amount of storage capacity, such as 256 MB. This can be useful in certain applications, such as systems configured to conform to a T10/T13 ISO Standard where data are managed as larger multi-sector data blocks. It will be appreciated that FIG. 5 is not drawn to scale, so that many more data zones than are shown can be accommodated on each recording surface. The tracks can take any number of suitable forms including shingled magnetic recording (SMR) tracks, etc.

FIG. 5 further shows a disc media cache 156. The disc media cache represents a portion of the media surface to which data may be cached instead of transferred to one or more of the main store data zones 154. As will be recognized, media caches such as 156 can support high I/O access rate transfers with a host, since random and sequential data writes can be streamed to the media cache area, and cached data to be quickly read from the media cache. This allows the device 100 to subsequently schedule the relocation of the data out of the media cache and into a final location in the disc stack (zones 154) at any suitable time.

It will be noted that the disc media cache 156 is shown to be located near the OD of each of the media surfaces (see FIG. 4). This is based in part on the fact that this location on the discs tends to have the highest data transfer rates, and therefore serves as an advantageous location on the media for fast accesses. However, the disc media cache can be placed at any suitable location or locations, including multiple non-adjacent locations at different radii across the recording surfaces.

FIG. 6 shows a memory hierarchy of the data storage device 100 in accordance with some embodiments. In addition to the main store data zones 154 and the disc media cache 156, depending on the configuration of the device a number of different, additional volatile and non-volatile memory locations may be available to store user data from the host. These memory locations include a front-end volatile memory (e.g., DRAM, SRAM, etc.), a NVM write cache 164, and a flash memory 166. In some cases, a volatile memory such as DRAM may be power protected using back-EMF generated power from the spindle motor, enabling a transfer of data prior to device shutdown.

These various memory locations (DRAM, write cache, flash, media cache) are collectively referred to as local memory locations, in contrast to the main store memory locations supplied by the disc stack data zones 154. Generally, data sets may be temporarily or permanently located in these local memory locations. Data may be intentionally not migrated to the main store (e.g., pinned to the local memory) for a variety of reasons such as high priority data, data that is frequently updated, etc. Cleaning operations can be scheduled to migrate or copy data from the local memory locations to the main store.

The local memory locations are available for use by the controller 102 as required. Cached readback data may be temporarily stored in the DRAM/SRAM local memory 160. Processed input write data may be temporarily stored in the write cache 162. Pinned data, such as frequently accessed hot data sets may be pinned to the flash memory 164, particularly in a hybrid drive environment. The disc media cache 156 can further be used as desired to provide two-stage disc writes to maintain desired host access transfer rates.

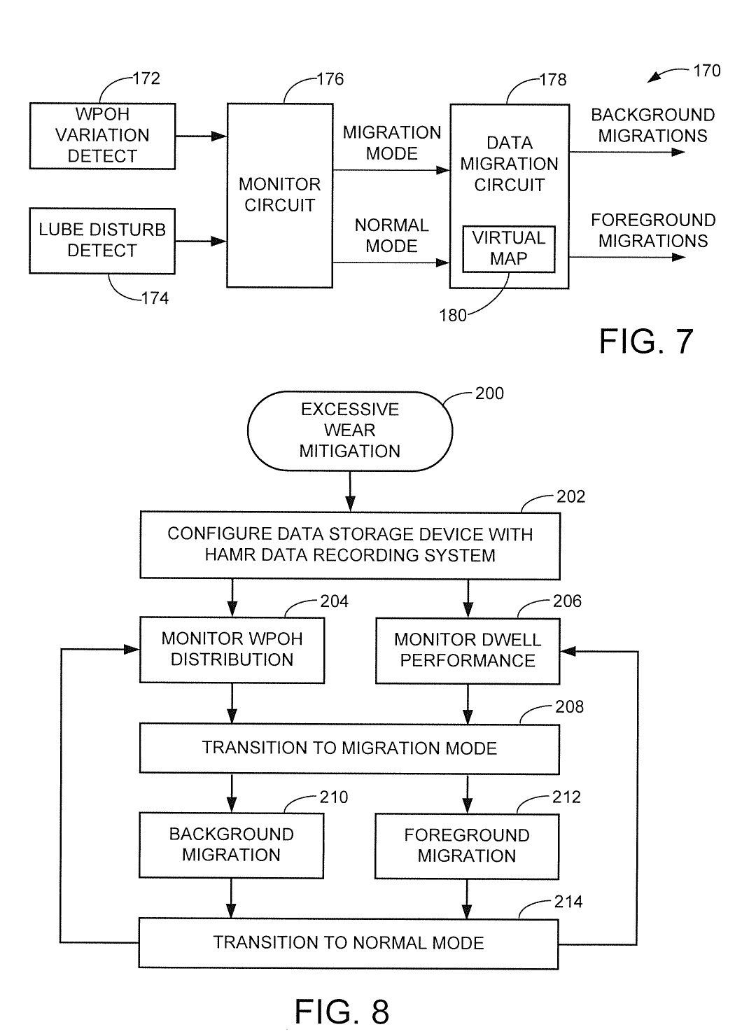

FIG. 7 shows a functional block representation of a wear mitigation circuit 170 of the data storage device 100 in accordance with various embodiments. The circuit 170 may form a portion of the controller 102 of the data storage device, and may be realized using hardware circuits and/or one or more programmable processors which execute associated programming (e.g., software/firmware) in a processor memory.

The circuit 170 includes a number of operational modules including a WPOH variation detection circuit 172, a lube disturb detection circuit 174, a monitor circuit 176, and a data migration circuit 178. A map 180 is maintained as a data structure in memory to track the locations of the data sets stored throughout the system. The map may take a variety of forms including separate map structures for the different memory locations.

As explained below, the detection circuits 172, 174 monitor various parameters to provide indications that an excessive wear condition is present. If so, the monitor circuit 176 transitions from a normal mode of operation to a data migration mode. The data migration circuit 178 operates to perform data migration operations to enhance the level loading of the system by temporarily migrating certain data sets to one or more of the local memory locations of the system (see FIG. 6).

FIG. 8 provides a flow chart for an excessive wear mitigation routine 200 generally illustrative of steps carried out by the circuit 170 of FIG. 7 in some embodiments. The routine commences at step 202 where a data storage device is configured with multiple data transducers (heads) and associated data recording surfaces. While not limiting, the present example will contemplate that each of the heads is a HAMR-based transducer as discussed above in FIG. 3.

Normal operation is commenced to service various host access (e.g., read and write) commands to transfer user data between the host device and the data storage device. During such transfers, input write data sets are ultimately written to destination location in various data zones 154 and may pass through various ones of the local memory locations. Data read commands are serviced by retrieving the requested data from the main store (zones 154) or, if available, as cache read hits from one of the local memory locations. The virtual map 180 is updated to track and locate the various data sets throughout the system.

During such normal operation, various parameters are monitored including a WPOH distribution for the various heads, step 204, and dwell performance relative to localized positions on the various disc surfaces, step 206.

Should one or more of these parameters indicate the presence of a potential or actual wear condition, the flow passes to step 208 where the circuit 170 transitions to a data migration mode. The data migration mode generally involves multiple processes that may operate in parallel; a background operation, step 210 and a foreground operation, step 212. Each of these operations will be discussed below, but at this point it will be noted that these processes continue until such time that the system transitions back to the normal mode of operation, as shown by step 214, although it is not necessarily required that the drive do so. This transition includes the transfer of the cached data back to the final disc main memory store. While not shown in FIG. 8, it will be appreciated that the virtual map structure 180 may be updated at this time once the data have been returned to the main store.

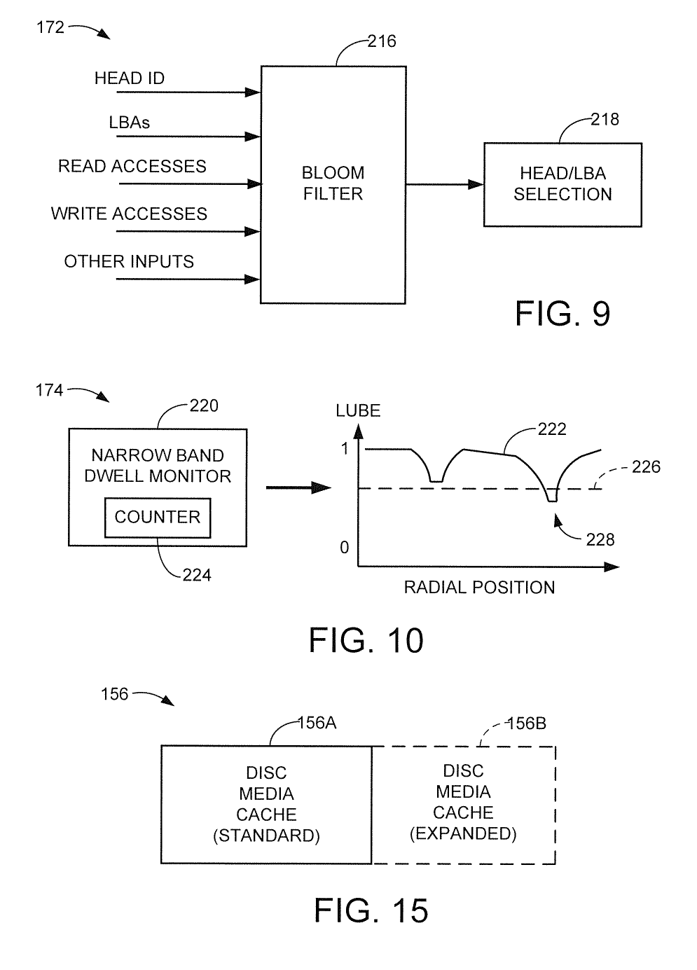

The wear monitoring steps 204, 206 can be carried out in any number of suitable ways. FIG. 9 shows a bloom filter 216 that can utilize a number of inputs to identify data that should be migrated.

WOPH issues can be detected through a simple accumulation of WPOH values for each head, the use of adjusted WPOH values based on various factors (e.g., write power, writing location, etc.). Other metrics can be used as well including total joules heating values for NFTs, hours of remaining estimated life, etc. It is noted that these and other factors may be referred to herein as operational life metric values, as these indicate a measure of the total operational elapsed time for each head. Hence, operational life metric values can be applied to both HAMR and non-HAMR heads.

FIG. 10 shows a narrow band dwell monitor circuit 220 which may form a portion of the lube disturb detection circuit 162 of FIG. 6. Other forms of detection can be used. As noted above, maintaining a data head in a relatively localized position such as over a narrow band of adjacent tracks for an extended period of time can cause a lube disturb condition where the normalized thickness of the lubricant is disturbed or displaced. In some embodiments, the circuit 220 uses a mathematical model based on empirical information to predict zones of reduced lubricant thickness, as generally indicated by lubricant thickness curve 222.

The model can use various inputs including the number of recent servo track positions, the number of recent write accesses, the number of recent read accesses, temperature, etc. to estimate a localized change in lubricant thickness. Counter circuitry such as at 224 can be used to accumulate various counts of these and other parameters. A selected threshold value, indicated by dashed line 226, can be utilized to determine that a lube disturb event has taken place at that location if a portion of the calculated curve 222 extends below this threshold line 226, as indicated at region 228. Hence, one manner in which the monitor circuit 176 (FIG. 7) can signal a transition to the data migration mode is through monitoring the output of the circuit 220. The threshold 226 can be any suitable value, such as but not limited to 0.8 (80% of the normal lube thickness).

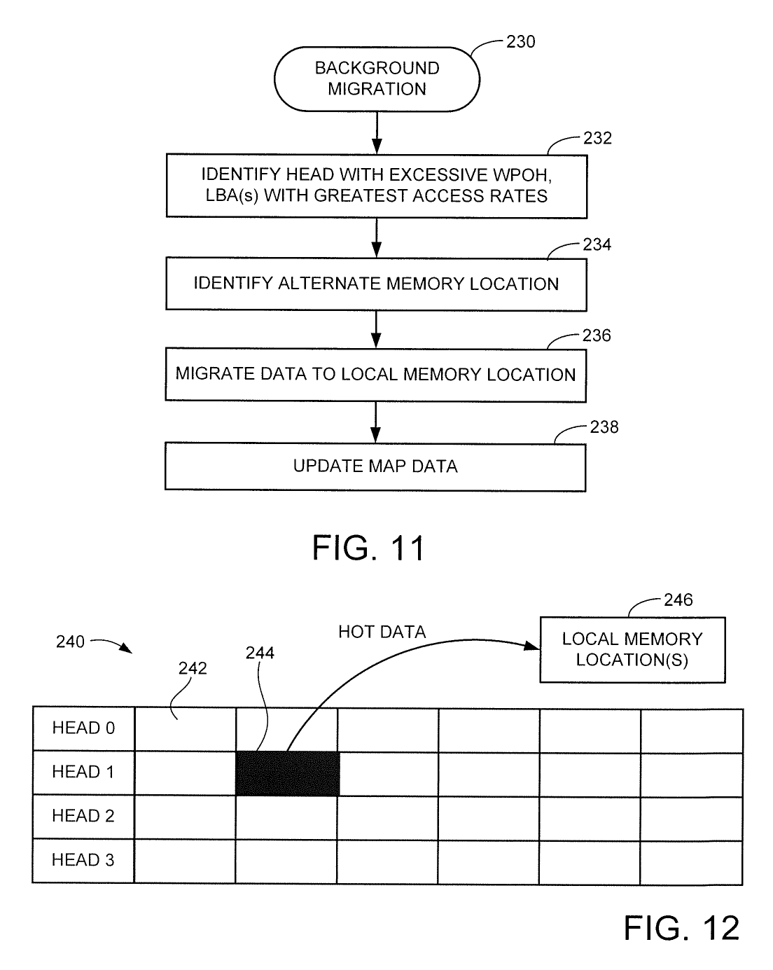

FIG. 11 is a flow chart for a background migration routine 230 that corresponds to the background migration step 210 of FIG. 8. Generally, the background migration operation is carried out initially when a wear condition is detected and the system transitions to the data migration mode, and primarily handles data sets that are currently stored to the main disc store (e.g., zones 154). However, this is not required; background mode can be optional and can be carried out for an extended period of time.

The background operation includes step 232 which identifies the selected head that has the greatest amount of wear, such as the highest WPOH value in terms of consumed life or lowest WPOH in terms of remaining life, as well as one or more LBAs on the associated surface that has the greatest activity. The LBAs may correspond to a region with the greatest lubricant disturbance, as noted in FIG. 10. However, if a data migration event is declared, the hottest (most frequently accessed) data sets will be identified even if the narrow band dwell monitor determines that the lube is not disturbed below the indicated threshold (line 178).

The amount of data to be temporarily migrated from off of the disc surface for the selected head can depend on a number of factors. In some cases, one or more blocks of data (e.g., zones 154) may be selected. In other embodiments, the data associated with some plural number n of adjacent tracks is selected. In cases where shingled magnetic recording (SMR) is used in which bands of partially overlapping tracks are written, an appropriate number of bands of such tracks may be selected (e.g., the data sets may be divided at appropriate band boundaries).

As noted above, one general principle that may be carried out during the background operation is to temporarily remove the relatively hottest data from the excessively worn heads or media locations and promote this data to one of the local memory locations. This provides a number of benefits such as enhancing level load the wear of the heads as well as to provide enhanced servicing of the commands associated with the data from a faster local memory location. In cases of lube disturb, the temporary promotion of the data further serves to reduce or prevent possible or actual lube disturb effects where off-track errors or other lube disturb effects may occur in the near future. The system is thus proactive and the data may be migrated before any actual disturbances are encountered. As noted above, lube depletion induces ridges that can cause fly height issues and, even worse, head disc contact events.

An alternative memory location for the data is selected at step 234. This may include one or more of the local memory locations shown in FIG. 8. In some cases, a progressive approach may be used so that data are initially moved to the disc media cache 156, followed by the flash memory 164, and so on depending on the extent to which access commands continue to be serviced for the data. It is contemplated that the data migrated off the main store may be distributed among different memory locations.

The data are physically migrated at step 236 to the new location. Because disc memory is non-volatile, the data migration may be in the form of a copy operation so that a copy of the data is moved to the local memory while the tracks on the disc continue to store the same data. If the data sets are returned to the original location, only those data sets that were updated with new versions need to be rewritten in a non-SMR environment. If shingled tracks are used, new bands of successively overlapping tracks will generally need to be written. Hence, the use or non-use of SMR techniques may influence the final location where the data are rewritten when the data are returned to the main store.

Finally, FIG. 11 shows that the map data are updated to reflect the new location(s) for the data. This enables the system to track the locations of the migrated data, track any updates on an individual LBA basis, and enable the system to both service ongoing access commands as well as coordinate the eventual cleaning of the data sets back to disc.

FIG. 12 is a simplified diagram of a main store map 240 of the main disc store region of the device 100. The data map structure 240 includes a number of relatively large data blocks 242. Each data block 242 may correspond to the respective data zones 154 in FIG. 5 and may represent, for example, a large amount of logically contiguous (e.g., LBA sequential) data sectors to provide a total amount of data storage such as 256 MB of data. Each row of the blocks represents the data blocks for one of the associated heads 0-3. The monitor circuit 176 (FIG. 7) may operate to maintain a separate set of parameters for each of the respective blocks 242.

A selected data block 244 for head 1 is shown in solid black, indicating that this particular block of data are identified as hot data that require migration to a new location. This corresponds to the first zone that is selected at step 234 in FIG. 11. The data are migrated by being copied to one or more suitable local memory locations 246, which as noted above could be the disc media cache, flash, etc. Access commands for the data sets are thereafter carried out from the local memory location(s) 246 during the pendency of the migration mode for that set of data. It will be noted that multiple sets of data may be concurrently migrated to the local memory, including from different media surfaces, and the data sets may be returned to the main disc store at different times.

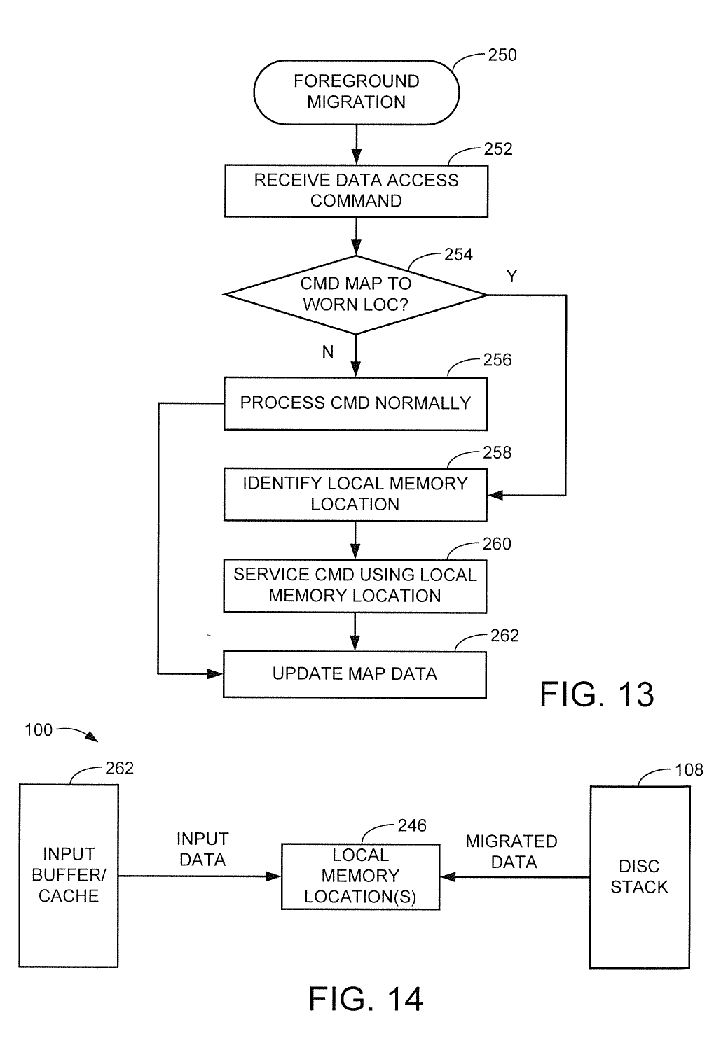

FIG. 13 is a flow chart for a foreground migration operation 250, as indicated by step 212 in FIG. 8. Generally, the foreground migration operation handles subsequent data access commands received from the host device for the migrated data. The foreground operation may be the migrator of data. One possibility is that the background mode is not used, so that all data migrations are carried out as foreground operations. Another possibility is that a foreground operation migrates the data prior to the background operation accomplishing the migration.

A new data access command is received from a selected host device at step 252. This will generally be a data write or a data read command, although other forms of commands are contemplated as well. A determination is made at decision step 254 whether the received data access command is associated with the migrated data (or data identified to be migrated); if not, the flow passes to step 256 where the command is processed normally. Such normal processing may include steps such locating and retrieving a copy of requested data to service a read command, processing and writing a copy of write data to a suitable target memory location, and so on as described above. From this it can be seen that during the data migration mode, some data sets will be handled in a normal fashion while other data sets will be processed separately. In some cases, any write commands to the disc surface associated with the selected head may be diverted to flash or elsewhere, even if the write commands are associated with a different LBA not forming a part of the migrated data, to reduce wear on the selected head.

Should the received data write command be associated with the wear condition, the flow passes from step 254 to step 258 where the associated local memory location is identified, and the command is serviced using that location, step 260. For example, a read command for data migrated to the local memory during the background operation of step 250 will be serviced from that location. A write command to write new data will result in the updated data being written to the local memory location rather than to disc, and so on. As before, the map data is updated to reflect the location(s) of the variously migrated data.

FIG. 14 is a functional block representation of aspects of the data storage device 100 during the background and foreground operations of FIGS. 11 and 13. As can be seen from FIG. 14, migrated data are promoted to the local memory location(s) 246 from the main disc store (disc stack) as part of the background processing, and new input data are diverted and held up in the local memory location(s) 246 during the concurrent foreground processing.

FIG. 15 shows the disc media cache 156 in greater detail. In some cases, depending upon the amount of migrated data, it may become desirable to expand the existing capacity of the disc media cache 156 to accommodate additionally migrated data. This is represented in FIG. 15 using a standard portion 156A, representing a first amount of data capacity for the disc cache media, and an expanded portion 156B which is made available to and incorporated into the disc cache media. As noted above, the respective portions 156A, 156B may be contiguous or non-contiguous on one or more of the disc surfaces.

The migration of data back to the main disc store can be scheduled as required. In some embodiments, the continued level of host accesses associated with the migrated data is monitored, and at such time that the access history shows reduced host interest, the data can be returned to the disc stack main store that at a suitable time. Depending on the variation in head wear, the returned data that is transferred from the local memory back to the main disc store can be returned to the original location, or can be migrated to a new location such as a block/head combination that exhibits relatively low wear. This is the use case for the mapping described in FIG. 12. A final map update operation is carried out once the final disc location for the data is determined.

It will now be appreciated that monitoring multiple parameters relating to wear in a proactive manner can result in improved data reliability and availability. While various embodiments have been disclosed that utilize HAMR heads to level load operational life metrics, similar operational life level loading can be used for other configurations including non-HAMR heads, etc. Similarly, other dwell related factors apart from lubricant disturbance can be used to trigger wear mitigation as required by the requirements of a given application.

It is to be understood that even though numerous characteristics and advantages of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method comprising:
recording data to a first rotatable data recording surface using a first data transducer;
accumulating a dwell metric value indicative of at least a selected one of dwell time of the first transducer adjacent a selected location on the first rotatable data recording surface or an operational life metric value indicative of accumulated elapsed operation of the first transducer;
migrating data from the selected location to a local memory responsive to at least a selected one of the dwell metric value or the operational life metric value exceeding a selected predetermined threshold; and
servicing at least one subsequently received access command for the data using the local memory without accessing the selected radial location on the first rotatable data recording surface and without using the first data transducer/

2. The method of claim 1, further comprising subsequently transferring the data from the local memory to the first rotatable data recording surface using the first data transducer or to a different, second rotatable data recording surface using a different, second data transducer.

3. The method of claim 1, wherein the dwell metric value comprises an estimate of lubricant disturbance of a lubricant layer on the first rotatable data recording surface adjacent the selected radial location.

4. The method of claim 1, wherein the operational life metric value comprises a total time duration value associated with operation of the first data transducer in writing data to the first data recording surface, the total time duration value comprising a selected one of accumulated operation or estimated remaining operation until end of life.

5. The method of claim 1, wherein the local memory comprises a flash memory.

6. The method of claim 1, wherein the local memory comprises a disc media cache comprising a portion of a rotatable data recording surface serviced by a data transducer.

7. The method of claim 6, wherein the disc media cache has an initial overall data storage capacity, and the migrating data step comprises increasing the overall data storage capacity to accommodate the migrated data.

8. The method of claim 1, wherein the first data transducer comprises a write element and an electromagnetic radiation (EMR) source of a heat assisted magnetic recording (HAMR) system to direct electromagnetic radiation to the first rotatable data recording surface during writing of data by the write element, and the operational life metric value indicates a total accumulated amount of time during which the EMR source has been activated.

9. The method of claim 1, further comprising maintaining a map as a data structure in a memory location which associates logical addresses of user data sectors to physical locations on the first and second data recording surfaces, and updating the map to reflect the migration of the data migrated to the local memory.

10. The method of claim 1, wherein the migrating step is carried out responsive to an indication that the dwell metric value has exceeded a first predetermined threshold and the operational life metric value has exceeded a second predetermined threshold.

11. The method of claim 1, wherein the first and second data transducers are characterized as heat assisted magnetic recording (HAMR) heads each having a laser diode and a near field transducer (NFT) which cooperate to irradiate localized regions of the respective first and second rotatable data recording surfaces with electromagnetic radiation as an associated magnetic write element in each of the respective first and second data transducers applies a magnetic write field to the localized region to record data thereto, wherein the operational life metric value represents a write power on hour (WPOH) value associated with consumed or remaining time, and wherein the data are subsequently transferred from the local memory to the second rotatable data recording surface responsive to the first transducer having a higher WPOH value as compared to the second transducer.

12. An apparatus comprising:
a first data transducer configured to be supported adjacent a first rotatable data recording surface to write data thereto;
a second data transducer configured to be supported adjacent a second rotatable data recording surface to write data thereto;
a local memory comprising non-volatile memory not accessible by the first or second data transducers; and
a wear mitigation circuit configured to accumulate a dwell metric value indicative of relative dwell time of the first transducer adjacent a selected radial location on the first data recording surface and an operational life metric value indicative of accumulated elapsed operation of the first transducer, to migrate data from the selected radial location to the local memory responsive to at least a selected one of the dwell metric value or the operational life metric value exceeding a selected predetermined threshold, and to subsequently transfer the data from the local memory to a selected one of the first or second rotatable data recording surfaces using the associated one of the first or second data transducers responsive to a host access rate associated with the data stored in the local memory.

13. The apparatus of claim 12, wherein the local memory comprises a non-volatile semiconductor memory.

14. The apparatus of claim 12, wherein the wear mitigation circuit is further configured to service at least one access command, received from a host device, to transfer a portion of the data between the local memory and the host device without accessing the selected radial location on the first rotatable data recording surface and without using the first data transducer.

15. The apparatus of claim 12, wherein the wear mitigation circuit comprises:
a dwell monitor circuit configured to accumulate first and second dwell metric values for the respective first and second data transducers indicative of relative dwell times adjacent associated locations on the first and second rotatable data recording surfaces;
an operational life monitor circuit configured to accumulate first and second operational life metric values indicative of accumulated elapsed operation of each of the first and second data transducers;
a monitor circuit configured to compare the first and second dwell metric values to a first threshold and to compare the first and second operational life metric values to a second threshold; and
a data migration circuit which migrates the data from the selected location to the local memory based on at least a selected one of a relative difference between the first and second dwell time values or a relative difference between the first and second operational life metric values.

16. The apparatus of claim 15, wherein the first and second dwell metric values comprise an estimate of localized lubricant disturbance of a respective first lubricant layer on the first data recording surface and a second lubricant layer on the second data recording surface.

17. The apparatus of claim 15, wherein the first and second operational life metric values comprises respective total numbers of operational hours associated with each of the first and second data transducers.

18. The apparatus of claim 12, wherein the operational life metric value is a write power on hours (WPOH) value.

19. The apparatus of claim 12, wherein the wear mitigation circuit further updates a map as a data structure in a memory responsive to the migration of the data to the local memory.

20. The apparatus of claim 12, wherein the first and second data transducers are characterized as heat assisted magnetic recording (HAMR) heads each having a laser diode and a near field transducer (NFT) which cooperate to irradiate localized regions of the respective first and second data recording surfaces with electromagnetic radiation as an associated magnetic write element in each of the respective first and second data transducers applies a magnetic write field to the localized region to record data thereto, wherein the operational life metric value represents a write power on hour (WPOH) value, and wherein the first transducer has a higher WPOH value as compared to the second transducer.
